(19) United States
(12) Patent Application Publication
(10) Pub. No.: US 2026/0336394 A1
(43) Pub. Date: Oct. 29, 2026

(54) A VEHICLE, AND A CONTROL METHOD FOR SUCH VEHICLE

(71) Applicant: BorgWarner Sweden AB, Landskrona (SE)

(72) Inventors: Ola NICKLASSON, MÖRARP (SE); Pierre PETTERSSON, Lund (SE); Mattias MAGNUSSON, Flyinge (SE)

(21) Appl. No.: 19/117,680

(22) PCT Filed: Oct. 3, 2023
(86) PCT No.: PCT/EP2023/077318

§ 371 Date: Apr. 2, 2025

(30) Foreign Application Priority Data
Oct. 3, 2022 (SE) 2251147-1

(51) Int. Cl. B60K 23/04; B60K 17/348; B60K 23/08

(52) U.S. Cl. CPC B60K 23/04; B60K 17/348; B60K 23/0808; B60K 2023/043

(57) ABSTRACT

A vehicle including at least two drive axles and at least one torque vectoring unit arranged on one of said drive axles thus forming a torque vectoring axle. The vehicle further comprises includes a control unit configured to determine a specific torque corresponding to a desired torque vectoring requirement for the vehicle . When the drive torque supplied to the torque vectoring axle is not sufficient to realise the specific torque, the control unit is further configured to i) redistribute the net vehicle drive torque between said drive axles by increasing the absolute value of the drive torque of the torque vectoring axle, and ii) distributing the increased drive torque of the torque vectoring axle to the left and right wheels.

### TECHNICAL FIELD

The present invention relates to the technical field of wheeled vehicles and control methods for such. In particular, the present invention relates to torque vectoring in vehicles.

### BACKGROUND

Wheeled vehicles may be multi-axle driven vehicles. One common type includes so called all wheel drive (AWD) vehicles. A primary vehicle axle is providing drive torque the associated wheel of the axle, and when AWD is requested a secondary axle is selectively controlled to also provide drive torque to its associated wheel. This feature can be implemented by mechanically connecting the secondary axle to the primary axle such that drive torque is distributed longitudinally. In hybrid cars an internal combustion engine may be in driving operation with the front (primary) axle, while the rear (secondary) axle may be driven by one or more electrical motors. Such vehicle may be operated in forward wheel drive (FWD), rear wheel drive (electric RWD), or in AWD (FWD plus RWD).

More modern cars are purely electric which means that one or more electrical motors are provided to drive the front axle, the rear axle, or both.

Vehicles may be equipped with torque vectoring, which is an effective technique for increasing yaw rate damping and improving vehicle stability during driving. Torque vectoring is normally applied to a single axle of the vehicle, whereby the drive torque to each one of the respective left and right wheels can be controlled.

There are different types of mechanisms for providing torque vectoring. For example, a torque vectoring axle may be based on superpositioning which means that a differential is distributing drive torque equally, while the torque vectoring mechanism distributes torque from one wheel shaft to the opposite wheel shaft. Such torque vectoring mechanism does not depend on the actual drive torque acting on the torque vectoring axle.

Another type of torque vectoring mechanism can be realized by individual propulsion motors acting on the left and right wheel, respectively. Also in this case the torque vectoring mechanism does not depend on the actual drive torque acting on the torque vectoring axle.

A further variant of a torque vectoring mechanism is dependent on the available drive torque on the torque vectoring axle. One example, which is further described below, requires a propulsion unit such as an electric motor which connects to the left wheel shaft by means of a first coupling and to the right wheel shaft by means of a second coupling. By individual control of the couplings the available drive torque provided by the propulsion unit is distributed left/right according to the desired torque vectoring request.

Hence, for the above-described torque vectoring mechanism there must be a drive torque acting on the axle in order to be able to shuffle drive torque between the left and right wheel of the vehicle axle. However, when there is no drive torque acting on the axle being provided with torque vectoring, there is no torque to distribute left and right. Existing vehicles with a torque vectoring mechanism described above, i.e. where the torque vectoring mechanism is dependent on the drive torque of the torque vectoring axle, may therefore suffer from the fact that torque vectoring is only available during a specific drive mode, such as AWD mode.

### SUMMARY

An object of the present invention is to solve the above-mentioned problem, and in particular to overcome the limitations of existing torque vectoring solutions for multi-axle driven vehicles.

An idea of the present invention is to redistribute the net vehicle drive torque between the driven axles of the vehicle in such way that the level of drive torque on the torque vectoring equipped axle/s satisfies the need to perform the desired left to right torque vectoring.

According to a first aspect, a vehicle is provided. The vehicle comprises at least two drive axles and at least one torque vectoring unit arranged on one of said drive axles thus forming a torque vectoring axle. The vehicle further comprises a control unit configured to determine a specific torque corresponding to a desired torque vectoring requirement for the vehicle. When the absolute value of drive torque supplied to the torque vectoring axle is less than, or not sufficient to realise the determined specific torque, the control unit is further configured to i) redistribute or at least request a redistribution of the net vehicle drive torque between said drive axles by increasing the drive torque of the torque vectoring axle, and ii) distributing the increased drive torque of the torque vectoring axle to the left and right wheels.

The torque vectoring unit is preferably configured to control the drive torque to each one of the left and right wheels. Hence, the torque vectoring unit is configured to actively control the lateral distribution of the drive torque supplied to the torque vectoring axle.

The vehicle may comprise a front drive axle, a rear drive axle, and optionally one or more intermediate axles. It is thus possible to utilize the present invention for passenger cars, trucks, buses, constructional equipment, etc.

The torque vectoring unit may comprises a right wheel clutch and a left wheel clutch. The right wheel clutch and the left wheel clutch are independently controllable. The torque vectoring axle can then be made very compact with great design freedom since the two clutches will act as a differential with built in torque vectoring functionality.

When the drive torque supplied to the torque vectoring axle is not sufficient to realise the specific torque, the control unit is preferably configured to i) redistribute the net vehicle drive torque between said drive axles such that at least the specific torque is distributed to the torque vectoring axle, and ii) distributing the specific torque of the torque vectoring axle to the left and right wheels.

According to a second aspect, a method for a vehicle is provided. The vehicle comprises at least two drive axles and at least one torque vectoring unit arranged on one of said drive axles thus forming a torque vectoring axle. The method comprises i) determining a specific torque corresponding to a desired torque vectoring requirement for the vehicle, ii) determining the drive torque supplied to the torque vectoring axle. When the determined absolute value of drive torque of the torque vectoring axle not sufficient to realise the specific torque the method further comprises iii) redistributing the net vehicle drive torque between said drive axles by increasing the absolute value of drive torque to the torque vectoring axle, preferably such that at least the determined specific absolute value of torque is distributed to the torque vectoring axle, and iv) distributing the increased drive torque, preferably to an amount corresponding to the specific torque of the torque vectoring axle, to the left and right wheels.

In an embodiment, redistributing the net vehicle drive torque between said drive axles comprises adding drive torque to the torque vectoring axle and subtracting drive torque from the other drive axle. There is then no change in the net vehicle drive torque, whereby torque vectoring will be allowed without affecting the vehicle longitudinal acceleration.

Subtracting drive torque from the other drive axle may be performed by reducing the drive torque. This is advantageous if there is already a positive drive torque acting on the other drive axle.

Subtracting drive torque from the other drive axle may be performed by applying a negative torque. This is particularly advantageous if the other drive axle is an electric drive axle.

Adding drive torque to the torque vectoring axle may be performed simultaneously as subtracting drive torque form the other drive axle. In such way there is a smooth redistribution of the net vehicle drive torque thereby reducing any unwanted vehicle behaviour.

Redistributing the net vehicle drive torque between said drive axles may be performed simultaneously as distributing the specific torque of the torque vectoring axle to the left and right wheels. This further improves vehicle behaviour during torque vectoring.

Reaching the desired absolute torque level on the torque vectoring axle may also be achieved by adding more negative drive torque to the torque vectoring axle. This is favourable if there is already negative drive torque on the torque vectoring axle. In that scenario the other axles drive torque may be altered with corresponding positive drive torque to achieve an unaltered net vehicle drive torque.

### BRIEF DESCRIPTION OF THE DRAWINGS

In the following, reference will be given by the appended drawings in which:

FIG. 1 is a schematic view of a vehicle according to an embodiment;

FIG. 2 is a schematic view of a torque vectoring axle of a vehicle according to an embodiment;

FIG. 3 is a schematic view of a method according to an embodiment;

FIG. 4 is a diagram showing the torque distribution of a vehicle according to prior art;

FIGS. 5 and 6 are diagrams showing the torque distribution of a vehicle according to different embodiments;

FIGS. 7a and 7b are schematic views of a torque vectoring axle during different drive modes; and

FIG. 8 is a diagram showing the torque distribution of a vehicle according to an embodiment.

### DETAILED DESCRIPTION

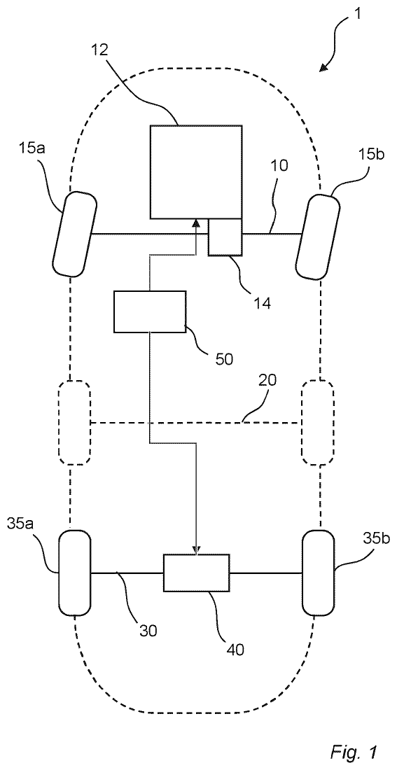

Starting in FIG. 1 a vehicle 1 is schematically shown. The vehicle 1 is a wheeled vehicle, comprising a plurality of wheel axles 10, 20, 30. A front axle 10 is a drive axle, i.e. it is provided with some kind of propulsion unit 12. In the shown example the propulsion unit 12 can e.g. be an internal combustion engine or an electric motor. The propulsion unit 12 provides drive torque to a differential 14 which in turn distributes the drive torque to the left and right front wheels 15a, 15b.

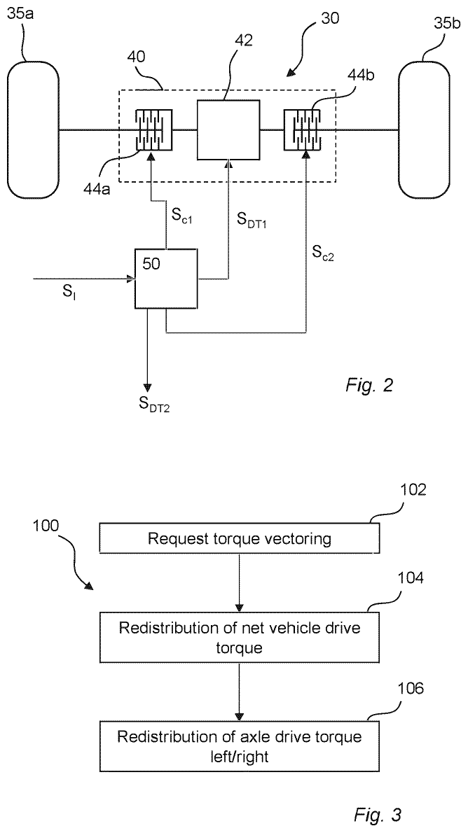

A rear axle 30 is provided, which is also a drive axle. Hence, the rear axle 30 has a propulsion unit 40 configured to provide a drive torque to the rear axle 30. The propulsion unit 40, which is further described with reference to FIG. 2, is configured to distribute the drive torque to the left and right rear wheels 35a, 35b. In particular, in the shown example the rear axle 30 is provided with means for torque vectoring, i.e. it is configured to actively redistribute drive torque between the left and right rear wheels 35a, 35b in order to improve driving performance, especially with regards to yaw rate damping, traction performance, and vehicle stability improvements. As explained in the background section, the torque vectoring axle 30 is configured such that torque vectoring is dependent on the drive torque acting on the axle 30 meaning that the torque vectoring unit is configured to actively control the lateral (i.e. left/right) distribution of the drive torque.

As shown in FIG. 1 one or more additional axles 20 may be provided. Each intermediate axle may be a drive axle, or a non-driven axle. Further, one or more of the intermediate axles 20 may be provided with torque vectoring functionality. It should be further noted that the shown embodiment is only given as an example; further alternatives of the axle configuration are possible, e.g. the front axle 10 may be provided with torque vectoring means while the rear axle may or may not be provided with torque vectoring means.

The vehicle 1 further comprises a control unit 50 being connected to the two drive axles 10, 30 as will be further explained below.

The wheeled vehicle 1 may be a passenger car, meaning that there is no intermediate axle 20 present. The wheeled vehicle 1 may in other embodiments be a bus, a truck, construction equipment, or any other wheeled vehicle 1 as long as it has at least two drive axles 10, 30, of which at least one drive axle 10, 30 is a torque vectoring axle 30.

Now turning to FIG. 2 further details of the torque vectoring axle 30 are shown. The propulsion unit 40 comprises a propulsion motor 42, preferably an electric motor. The propulsion unit 40 further comprises a torque differentiation mechanism, here in the form of two individually controllable clutches 44a, 44b. The propulsion motor 42 provides input torque to both clutches 44a, 44b, and each clutch 44a, 44b has an output shaft connected to the respective left and right wheel 35a, 35b. In an example, the clutches 44a, 44b are hydraulically actuated disc clutches. If both clutches 44a, 44b are actuated by the same pressure the drive torque will be distributed equally between the left and right wheels 35a, 35b. In an extreme situation one clutch 44a is fully actuated while the other clutch 44b is left open, whereby the entire drive torque, positive or negative, is distributed to only one wheel 35a.

The control unit 50 is connected to each one of the propulsion motor 42 and the left and right clutches 44a, 44b. The control unit 50 is programmed to control the operation of each one of these components 42, 44a, 44b by sending corresponding control signals.

The control unit 50 is for simplicity illustrated as a single component. However, it should be realized that the control unit 50 can be designed in various ways. For example, the control unit 50 comprises a central processing unit (CPU), a computing module, and a memory device. The control unit 50 is provided with connections, such as noted above, providing a preferably constant communication mode for the control unit 50 to control torque vectoring as described further below.

The control unit 50 is a microprocessor based device, and includes the CPU enabled to process incoming information relating to torque vectoring, a RAM and/or ROM that functions as a volatile memory unit, along with associated input and output buses. The control unit 50 may be configured as an application specific integrated circuit, or may be formed through other logic devices that are well known in the art. More particularly, the control unit 50 either may form a portion of one or more of the vehicle's electronic control unit (ECU) modules, such as a torque vectoring ECU module and a propulsion ECU module, or may be alternatively configured as a stand-alone ECU. In a case where the control unit 50 is realized as a torque vectoring ECU module and a propulsion ECU module, the torque vectoring ECU module is controlling the clutches 44a, 44b while the propulsion ECU module is controlling the longitudinal torque distribution as will be further described below by request from the torque vectoring ECU module.

The control unit 50 is configured to send a control signal S_{DT1} to the propulsion motor, corresponding to the requested drive torque. The control unit 50 is further configured to send control signals S_{c1}, S_{c2} to the left and right clutches 44a, 44b corresponding to level of actuation representing the requested torque output from the respective clutches 44a, 44b. Also, the control unit 50 is configured to send a control signal S_{DT2} to the propulsion motor of the other drive axel 10. In order to transmitting these control signals, the control unit 50 receives an input signal S_{I} representing the requested need for torque vectoring during driving.

In the shown example the two clutches 44a, 44b together form a torque vectoring unit 45. Using two individually controllable clutches 44a, 44b is advantageous in that they can effectively disconnect the propulsion motor 42 from the drive train, if no drive torque is required for that particular drive axle 30. However, within the context of this invention other torque vectoring units 45 may be considered as are well known in the art.

The vehicle is controlled according to the following general method 100, as shown schematically in FIG. 3. In a first step 102, torque vectoring of a drive axle 30 is requested. The method 100 then determines if there is sufficient drive torque available for the torque vectoring axle 30. If not, in a second step 104 the net vehicle drive torque of the vehicle is redistributed such that the absolute drive torque of the torque vectoring axle 30 is increased while also reducing the same amount of drive torque from the other drive axle 10. Preferably, step 104 is performed such that the torque vectoring axle 30 has a sufficient drive torque to effect the requested torque vectoring. In step 106, which may be performed simultaneously as step 104, the drive torque of the torque vectoring axle 30 is redistributed between the left and right wheels 35a, 35b in accordance with the requested torque vectoring.

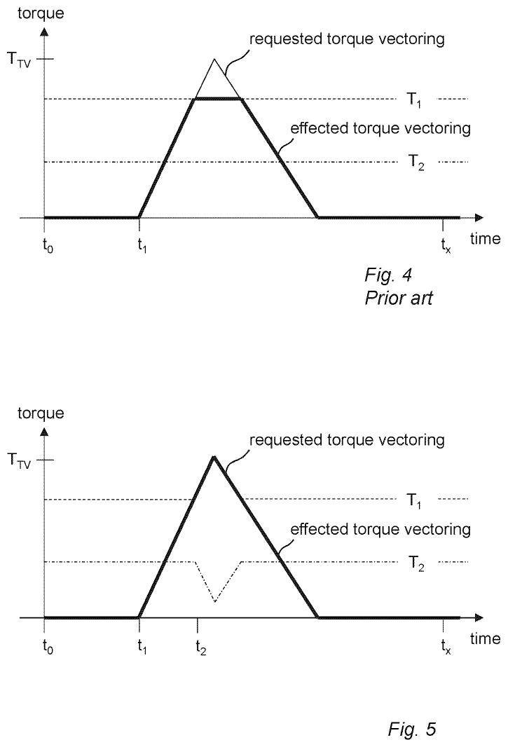

In order to further explain the invention, reference is made to FIG. 4 which shows a diagram exemplifying a prior art method for torque vectoring. Between times t₀ and tₓ the torque vectoring axle 30 is driven by a constant drive torque T₁ while the other axle 10 is driven by a constant drive torque T₂. The net vehicle drive torque for the vehicle 1 is then Tₜₒₜ=T₁+T₂.

At time t₁ torque vectoring is requested. The requested amount for torque vectoring, T_{TV}, is higher than the drive torque T₁ of the torque vectoring axle 30. According to what is known in the prior art, torque vectoring will be effected but only to the extent of the drive torque T₁ of the torque vectoring axle 30. Hence, the torque vectoring is not performed at the requested level.

An embodiment according to the present invention is shown in FIG. 5. Between times t₀ and tₓ the vehicle 1 is driven by a total net vehicle drive torque Tₜₒₜ, corresponding to the sum of the drive torque T₁ of the torque vectoring axle 30 and the drive torque T₂ of the other axle 10. Initially, the drive torque T₁ of the torque vectoring axle 30 and the drive torque T₂ of the other axle 10 are constant.

At time t₁ torque vectoring is requested. The requested amount for torque vectoring, T_{TV}, is higher than the initial drive torque T₁ of the torque vectoring axle 30. As torque vectoring is started, the redistributed torque between left and right wheels 35a, 35b will reach the current drive torque T₁ of the torque vectoring axle 30 at time t₂. In order to make more drive torque available for torque vectoring, the drive torque T₁ of the torque vectoring axle 30 is increased, preferably to reach the level required for the requested torque vectoring. At the same time the same amount of drive torque is subtracted from the drive torque T₂ of the other axle 10. The reverse procedure is performed when the requested torque vectoring is reduced, i.e. the increased drive torque T₁ of the torque vectoring axle 30 is reduced to reach the initial drive torque T₁ of the torque vectoring axle 30. At the same time the same amount of drive torque is added to the drive torque T₂ of the other axle 10. Hence, the net vehicle drive torque Tₜₒₜ, corresponding to the sum of the drive torque T₁ of the torque vectoring axle 30 and the drive torque T₂ of the other axle 10, will remain constant during torque vectoring.

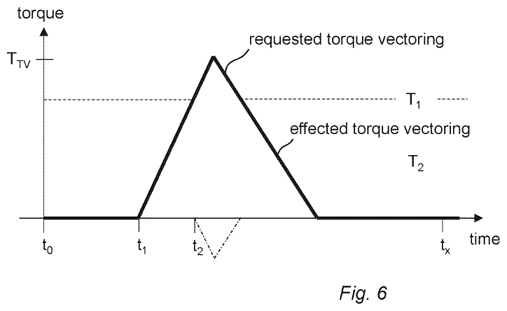

Another example of the torque vectoring procedure is shown in FIG. 6. Between times t₀ and tₓ the vehicle 1 is driven by a total net vehicle drive torque Tₜₒₜ, corresponding to the sum of the drive torque T₁ of the torque vectoring axle 30 and the drive torque T₂ of the other axle 10. Initially, the drive torque T₁ of the torque vectoring axle 30 is constant, while the drive torque T₂ of the other axle 10 is zero.

At time t₁ torque vectoring is requested. The requested amount for torque vectoring, T_{TV}, is higher than the initial drive torque T₁ of the torque vectoring axle 30. As torque vectoring is started, the redistributed torque between left and right wheels 35a, 35b will reach the current drive torque T₁ of the torque vectoring axle 30 at time t₂. In order to make more drive torque available for torque vectoring, the drive torque T₁ of the torque vectoring axle 30 is increased to reach the level required for the requested torque vectoring. At the same time, since the drive torque T₂ of the other axle 10 is zero, the same amount of drive torque is applied to the other axle 10 as a negative torque. Preferably, for such embodiment the other axle 10 has an electric motor whereby the negative torque can be a regenerative torque. The reverse procedure is performed when the requested torque vectoring is reduced, i.e. the increased drive torque T₁ of the torque vectoring axle 30 is reduced to reach the initial drive torque T₁ of the torque vectoring axle 30. At the same time the same amount of negative drive torque is removed from the other axle 10. Hence, the net vehicle drive torque Tₜₒₜ, corresponding to the sum of the drive torque T₁ of the torque vectoring axle 30 and the drive torque T₂ of the other axle 10, will remain constant during torque vectoring.

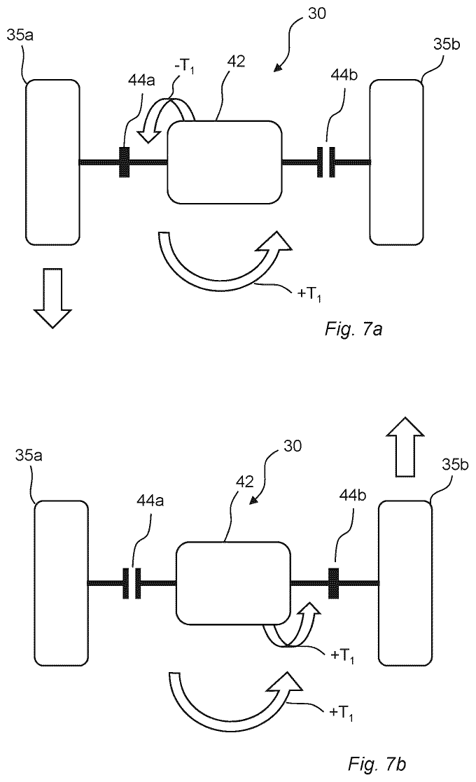

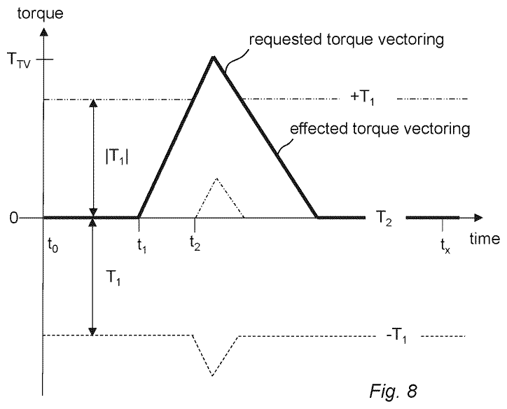

A further example is given with reference to FIGS. 7a-b and FIG. 8. In FIG. 7a a torque vectoring axle 30 is shown. The torque vectoring axle 30 is subject to a drive torque T₁ which is supplied by a negative torque −T₁ acting on the left wheel 35a only, i.e. the right clutch 44b is entirely open.

In FIG. 7b the torque vectoring axle 30 is subject to the same absolute drive torque T₁, but in this case the drive torque T₁ is supplied by a positive torque +T₁ acting on the right wheel 35b only, i.e. the left clutch 44a is entirely open. Hence, for both cases illustrated in FIGS. 7a and 7b the torque vectoring torque acting on the torque vectoring axle is the same.

In FIG. 8 a diagram is shown illustrating a torque vectoring procedure based on the driving condition shown in FIG. 7a. Between times t₀ and tₓ the vehicle 1 is driven by a total net vehicle drive torque Tₜₒₜ, corresponding to the sum of the drive torque T₁ of the torque vectoring axle 30 and the drive torque T₂ of the other axle 10. Initially, the drive torque T₁ of the torque vectoring axle 30 is constant by the negative torque −T₁ applied to the left wheel 35a only, while the drive torque T₂ of the other axle 10 is zero.

At time t₁ torque vectoring is requested. The requested amount for torque vectoring, T_{Tv}, is higher than the initial drive torque T₁ of the torque vectoring axle 30. As torque vectoring is started, the redistributed torque between left and right wheels 35a, 35b will reach the current drive torque T₁ of the torque vectoring axle 30 at time t₂. In order to make more drive torque available for torque vectoring, the drive torque T₁ of the torque vectoring axle 30 is altered to reach the level required for the requested torque vectoring. This is achieved by increasing the magnitude, or absolute value, of the negative torque −T₁. At the same time, since the drive torque T₂ of the other axle 10 is zero, the same amount of drive torque is applied to the other axle 10 as a positive torque. The reverse procedure is performed when the requested torque vectoring is reduced, i.e. the increased drive torque T₁ of the torque vectoring axle 30 is reduced to reach the initial drive torque T₁ of the torque vectoring axle 30. At the same time the same amount of drive torque is removed from the other axle 10. Hence, the net vehicle drive torque Tₜₒₜ, corresponding to the sum of the drive torque T₁ of the torque vectoring axle 30 and the drive torque T₂ of the other axle 10, will remain constant during torque vectoring.

It should be mentioned that the inventive concept is by no means limited to the embodiments described herein, and several modifications are feasible without departing from the scope of the invention as defined in the appended claims.

1. A vehicle, comprising at least two drive axles and at least one torque vectoring unit arranged on one of said drive axles thus forming a torque vectoring axle, and
a control unit configured to determine a specific torque corresponding to a desired torque vectoring requirement for the vehicle; and
when drive torque supplied to the torque vectoring axle is not sufficient to realise the specific torque, the control unit is further configured to:
redistribute a net vehicle drive torque between said drive axles by increasing an absolute value of the drive torque of the torque vectoring axle, and
distributing the increased drive torque of the torque vectoring axle to left and right wheels.

2. The vehicle according to claim 1, comprising a front drive axle, a rear drive axle, and one or more intermediate axles.

3. The vehicle according to claim 2, wherein the torque vectoring unit is configured to control lateral distribution of the drive torque to each one of the left and right wheels.

4. The vehicle according to claim 3, wherein the torque vectoring unit comprises a left wheel clutch and a right wheel clutch.

5. The vehicle according to claim 4, wherein the left wheel clutch and the right wheel clutch are independently controllable.

6. The vehicle according to claim 5, when the drive torque supplied to the torque vectoring axle is not sufficient to realise the specific torque, the control unit is configured to:
redistribute the net vehicle drive torque between said drive axles such that at least the specific torque is distributed to the torque vectoring axle, and
distributing the specific torque of the torque vectoring axle to the left and right wheels.

7. A method for a vehicle comprising at least two drive axles and at least one torque vectoring unit arranged on one of said drive axles thus forming a torque vectoring axle, said method comprising:
determining a specific torque corresponding to a desired torque vectoring requirement for the vehicle;
determining a drive torque supplied to the torque vectoring axle; and
when the determined drive torque of the torque vectoring axle is not sufficient to realise the specific torque the method further comprises:
redistributing a net vehicle drive torque between said drive axles by increasing an absolute value of the drive torque of the torque vectoring axle, and
distributing the increased drive torque of the torque vectoring axle to left and right wheels.

8. The method according to claim 7, wherein redistributing the net vehicle drive torque between said drive axles comprises adding the drive torque to the torque vectoring axle and subtracting the drive torque from the other drive axle.

9. The method according to claim 8, wherein the subtracting drive torque from the other drive axle is performed by reducing the drive torque.

10. The method according to claim 8, wherein the subtracting drive torque from the other drive axle is performed by applying a negative torque.

11. The method according to claim 10, wherein adding the drive torque to the torque vectoring axle performed simultaneously as subtracting the drive torque from the other drive axle

12. The method according to claim 11, wherein redistributing the net vehicle drive torque between said drive axles is performed simultaneously as distributing the specific torque of the torque vectoring axle to the left and right wheels.

13. The method according to claim 8, wherein adding the drive torque to the torque vectoring axle is performed simultaneously as subtracting the drive torque from the other drive axle.

14. The method according to claim 7, wherein redistributing the net vehicle drive torque between said drive axles is performed simultaneously as distributing the specific torque of the torque vectoring axle to the left and right wheels.

15. The vehicle according to claim 1, comprising a front drive axle and a rear drive axle.

16. The vehicle according to claim 1, wherein the torque vectoring unit is configured to control lateral distribution of the drive torque to each one of the left and right wheels.

17. The vehicle according to claim 1, wherein the torque vectoring unit comprises a left wheel clutch and a right wheel clutch.

18. The vehicle according to claim 17, wherein the left wheel clutch and the right wheel clutch are independently controllable.

19. The vehicle according to claim 1, when the drive torque supplied to the torque vectoring axle is not sufficient to realise the specific torque, the control unit is configured to:
redistribute the net vehicle drive torque between said drive axles such that at least the specific torque is distributed to the torque vectoring axle, and
distributing the specific torque of the torque vectoring axle to the left and right wheels.
